(19) United States
(12) Patent Application Publication
(10) Pub. No.: US 2026/0149723 A1
(43) Pub. Date: May 28, 2026

(54) MINIMIZATION OF UNUSED RESOURCE-ACCESS PERMISSIONS ACROSS ROLES

(71) Applicant: Veza Technologies, Inc., Los Gatos, CA (US)

(72) Inventors: Emily Liu, San Jose, CA (US); Chen Xu, Sunnyvale, CA (US); Maohua Lu, Fremont, CA (US); Tarun Thakur, Los Gatos, CA (US)

(21) Appl. No.: 19/399,250

(22) Filed: Nov. 24, 2025

Related U.S. Application Data
(60) Provisional application No. 63/724,768, filed on Nov. 25, 2024.

(51) Int. Cl. H04L 9/40

(52) U.S. Cl. CPC H04L 63/105; H04L 63/102

(57) ABSTRACT

The technology disclosed herein enables the reduction of unused, or excess, access permissions in roles assigned to users. In a particular example, a method includes identifying access permissions used by a user and applying a greedy algorithm to select a set of roles from a plurality of roles available for role-based access control (RBAC) to enable the access permissions. Each iteration of the greedy algorithm selects a different role for inclusion the set of roles based on a blast radius of the different role. The method further includes assigning the set of roles to the user; and enforcing the access permissions granted by the set of roles.

### RELATED APPLICATIONS

This application is related to and claims priority to U.S. Provisional Patent Application 63/724,768, titled “MINIMIZATION OF UNUSED RESOURCE-ACCESS PERMISSIONS ACROSS ROLES,” filed Nov. 25, 2024, and which is hereby incorporated by reference in its entirety.

### TECHNICAL BACKGROUND

Organizations commonly rely on identity platforms such as Microsoft Active Directory, Google Workspace, and AWS IAM to manage user and group access. While these systems are designed to simplify administration and improve security, they often result in users being granted far more permissions than they actually need. Over time, unused and excessive permissions accumulate, creating a significant security risk. Dormant accounts and over-provisioned roles can provide attackers with broad access if credentials are compromised. This situation is exacerbated by the complexity of modern enterprise environments, where thousands of roles and permissions exist across multiple systems. Addressing these excess permissions is critical to reducing the potential impact of a breach and ensuring that users operate under the principle of least privilege.

### SUMMARY

The technology disclosed herein enables the reduction of unused, or excess, access permissions in roles assigned to users. In a particular example, a method provides tracking used access permissions from a plurality of access permissions for a role that a user assigned the role uses during a period of time. The method further includes determining a different role with the used access permissions and assigning the different role to the user. Also, the method includes granting the user access to resources in accordance with the different role.

In another example, a method includes identifying access permissions used by a user and applying a greedy algorithm to select a set of roles from a plurality of roles available for role-based access control (RBAC) to enable the access permissions. Each iteration of the greedy algorithm selects a different role for inclusion the set of roles based on a blast radius of the different role. The method further includes assigning the set of roles to the user; and enforcing the access permissions granted by the set of roles.

In a further example, an apparatus is provided having one or more computer readable storage media and a processing system operatively coupled with the one or more computer readable storage media. Program instructions stored on the one or more computer readable storage media, when read and executed by the processing system, direct the apparatus to track access permissions used by a user. The program instructions further direct the apparatus to iteratively add a role to a set of roles until the access permissions are captured by the set of roles. Each added role does not increase a ratio of total permissions captured by the set of roles to permissions of the access permissions captured by the set of roles. The program instructions also direct the apparatus to assign the set of roles to the user to enforce permissions in the set of roles.

### BRIEF DESCRIPTION OF THE DRAWINGS

FIG. 1 illustrates an implementation for reducing the number of unused permissions assigned to users.

FIG. 2 illustrates an operation to reduce the number of unused permissions assigned to users.

FIG. 3 illustrates an operational scenario to reduce the number of unused permissions assigned to users.

FIG. 4 illustrates an operation to reduce the number of unused permissions assigned to users.

FIG. 5 illustrates an operation to reduce the number of unused permissions assigned to users.

FIG. 6 illustrates an operation to reduce the number of unused permissions assigned to users.

FIG. 7 illustrates an operational scenario to reduce the number of unused permissions assigned to users.

FIG. 8 illustrates a computing architecture for reducing the number of unused permissions assigned to users.

### DETAILED DESCRIPTION

To address excess permissions issues, the permission reduction engine described herein enforces the principle of least privilege, granting users and groups only the minimum access permissions needed for their job. The system assigns roles with specific access permissions to users or groups, ensuring the selected roles minimize unnecessary permissions. This process involves solving an NP-hard set-cover problem, which can be time-consuming due to the large number of roles, users, and permissions in an organization. The permission reduction engine uses a greedy algorithm offering a significant improvement, running 10-100 times faster than brute-force methods while achieving similar results in minimizing excessive permissions.

As user access needs and behavior evolve, the permission reduction engine tracks access history (e.g., the past 90 days) to update required permissions and re-assign roles accordingly. This continuous role assignment ensures adaptability to changing access patterns, maintaining the least privilege principle over time. By automating role recommendations based on real-time access data, the system enhances security and minimizes the risk of security breaches by reducing unnecessary permissions.

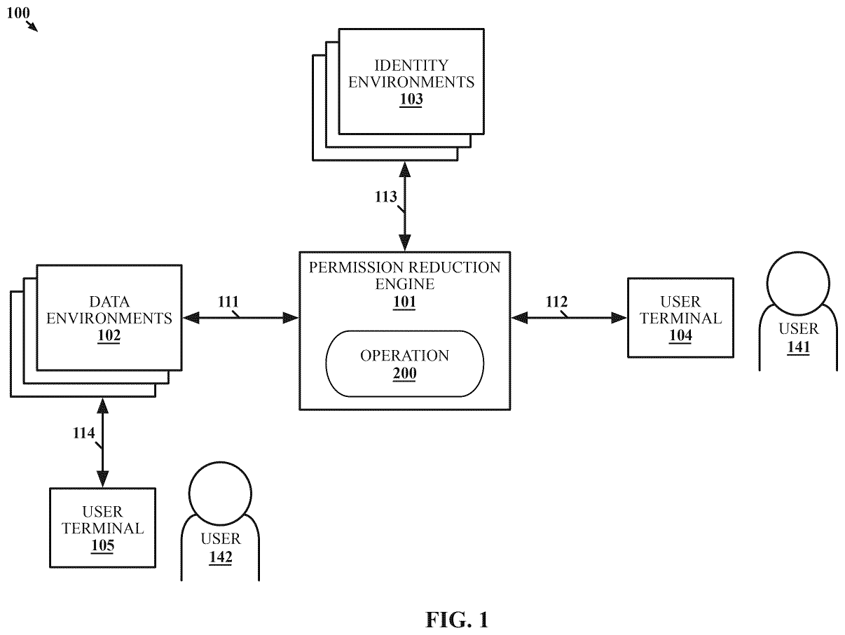

FIG. 1 illustrates an implementation for reducing the number of unused permissions assigned to users. Implementation 100 includes permission reduction engine 101, data environments 102, identity environments 103, user terminal 104, and user terminal 105. Permission reduction engine 101 and data environments 102 communicate over respective communication links 111. Permission reduction engine 101 and user terminal 104 communicate over communication link 112. Permission reduction engine 101 and user terminal 105 communicate over communication link 114. Permission reduction engine 101 and identity environments 103 communicate over respective communication links 113. While communication links 111-114 are shown as direct links, communication links 111-113 may include intervening systems, networks, and/or devices. Permission reduction engine 101 executes on one or more computing systems, such as server systems, having processing and communication circuitry to operate as described below. User terminals 104 and 105 are each a user operated computing system, such as a desktop workstation, laptop, tablet computer, smartphone, etc. User terminal 104 is operated by an administrative user 141 that configures permission reduction engine 101. User terminal 105 is operated by a user who accesses resources provided by data environments 102.

In operation, permission reduction engine 101 performs operation 200 to change roles of users stored in identity environments 103 to minimize the number of excess permissions associated with each user. Data environments 102 include one or more systems that host databases, such as databases for Online Transaction Processing (OLTP) and Online Analytical Processing (OLAP), tables, files, applications, or other computing resources provided to accessing systems—including combinations thereof. Identity environments 103 include one or more systems that maintain information about users (e.g., user identity information, user attributes, etc.) and information about which of data environments 102 (including specific resources therein) each user is allowed to access. Identity environments 103 may include an active directory (AD) server, an Okta® system, an Identity and Access Management (IAM) system, a privilege access management (PAM) system, human resources management system (HRMS), identity and access governance (IAG) system, or any other type of system that maintains the user information discussed above. Identity environments 103 maintain identity information about users that may access one or more of data environments 102. The identity information may include authorization information indicating whether given users are allowed to access particular resources provided by data environments 102 or ones of data environments 102 as a whole. In some examples, a data environment of data environments 102 may authorize a user itself based on identity information for the user included in identity environments 103. For instance, identity environments 103 may indicate information about a user, such as a work group for the user, the user's job title/role, a seniority of the user, a security clearance level for the user, or any other type of information that may affect which of data environments 102 the user can access. In further examples, a data environment of data environments 102 may authorize users independently.

Regardless of the arrangement between data environments 102 and identity environments 103 to determine access privileges of users, roles are used in identity environments 103 to allocate access permissions by grouping predefined permissions into specific roles, which are then assigned to users or groups based on their access needs. Each role defines a particular level of access to resources or data, specifying what actions can be performed and on what objects. By assigning a user or group one or more roles, the system attempts to ensure users receive only the permissions necessary for their job functions. This role-based access control (RBAC) model simplifies permission management and is intended to help maintain security by preventing users from having excessive or unnecessary access. However, the principle of least privilege is not always adhered to, especially in enterprises having large numbers of users, permissions, and roles. A role may include numerous permissions that users having the role do not need or otherwise never use.

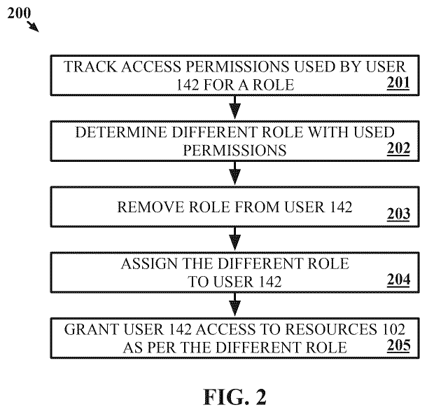

FIG. 2 illustrates operation 200 to reduce the number of unused permissions assigned to users. Operation 200 monitors permissions for a role used by users over a period of time and determines a replacement role for the users that does not include unused permissions from the original role. While only user 142 is discussed below, operation 200 may be performed in relation to access permissions of multiple users or groups of users, such has those having a particular role. During operation 200, permission reduction engine 101 tracks access permissions of a current role used by user 142 during a period of time (step 201). The period of time may be set to any length of time in which a user is likely to use all permissions necessary for their job. For example, if user 142 is expected to experience most, if not all, likely scenarios requiring resource access every 90 days, then the period of time may be set to 90 days. As such, any access permissions for a role that are not used during that period of time are assumed to be access permissions that are not necessary for use by user 142.

Permission reduction engine 101 then determines a different role having the used access permissions and as few as possible of the access permissions not used from the current role (ideally none of the unused permissions) (step 202). The different role may be created from scratch or may be selected from an existing role, such as a role defined by user 141. For instance, a different role may already exist in identity environments 103 only having the used access permissions from the current role. Alternatively, the existing role may still have unused access permissions (either from the current role or otherwise not used by user 142). In these examples, it may be preferable to select the existing role rather than create yet another role in identity environments 103 given the existing role includes a minimal number of excess access permissions. A greedy algorithm may be used by permission reduction engine 101 to select the different role. Unlike existing greedy algorithms for role selection, which may assume each set contains only required permissions, the greedy algorithm detailed below introduces a blast radius metric to account for extraneous permissions. This constraint ensures that role selection minimizes unnecessary access while still covering all required permissions, thereby improving security and reducing privilege creep.

Permission reduction engine 101 removes the current role from user 142 in identity environments 103 (step 203) and assigns the different role to user 142 in its place (step 204). Once user 142 is assigned the different role. Identity environments 103 grants the user access to resources of data environments 102 in accordance with the different role (step 205). Advantageously, the experience of user 142 when accessing the resources should be unchanged since the different role includes the permissions user 142 used during the period of time. Most, if not all, of the unused roles are not included in the different role thereby reducing the chances that one of user 142's unused permissions can be leveraged by an unwanted party.

In the above examples, a single role is replaced by another role. In some examples, user 142 may be assigned multiple roles. As such, to cover all the permissions used by user 142 multiple roles may be assigned to user 142. For instance, user 142 may have used 15 permissions. Permission reduction engine 101 may not identify a single role having all 15 permissions—or at least no single role having all 15 permissions without also having an unacceptable number of permissions that are not used by user 142. Permission reduction engine 101 may, therefore, select multiple roles that have the 15 permissions in the aggregate (e.g., if three roles are identified, one role may have 5 permissions, another 8, and another has the remaining 2). There may also be overlap with multiple identified roles having one or more permissions shared between the two.

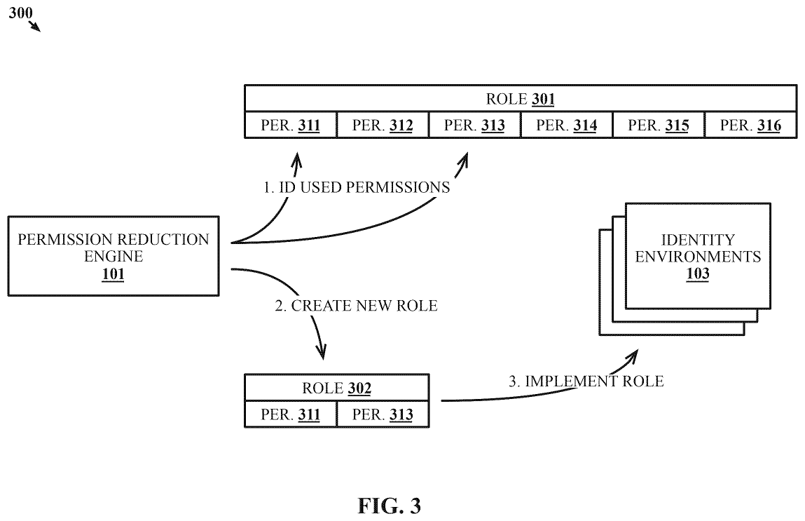

FIG. 3 illustrates operational scenario 300 to reduce the number of unused permissions assigned to users. In operational scenario 300, role 301 is assigned to user 142 and includes permissions 311-316. Over a predefined period of time, permission reduction engine 101 determines user 142 uses permission 311 and permission 313 but not permissions 312, 314-316 (step 1). Permission reduction engine 101 creates role 302 or selects role 302 from existing roles used in identity environments 103 (step 2). Role 302 is selected because role 302 only includes permission 311 and permission 313, although, other examples may include more than just permission 311 and permission 313. For instance, role 302 may also include permission 312 because, even though permission 312 was not used during the period of time, role 302 would still have fewer excess roles than role 301. Permission reduction engine 101 implements role 302 in identity environments 103 and replaces role 301 with role 302 for user 142. Role 301 may remain an available role in identity environments 103 because other users may still be assigned role 301. Although, if role 301 is no longer assigned to any user in identity environments 103, then permission reduction engine 101 may delete role 301 from identity environments 103.

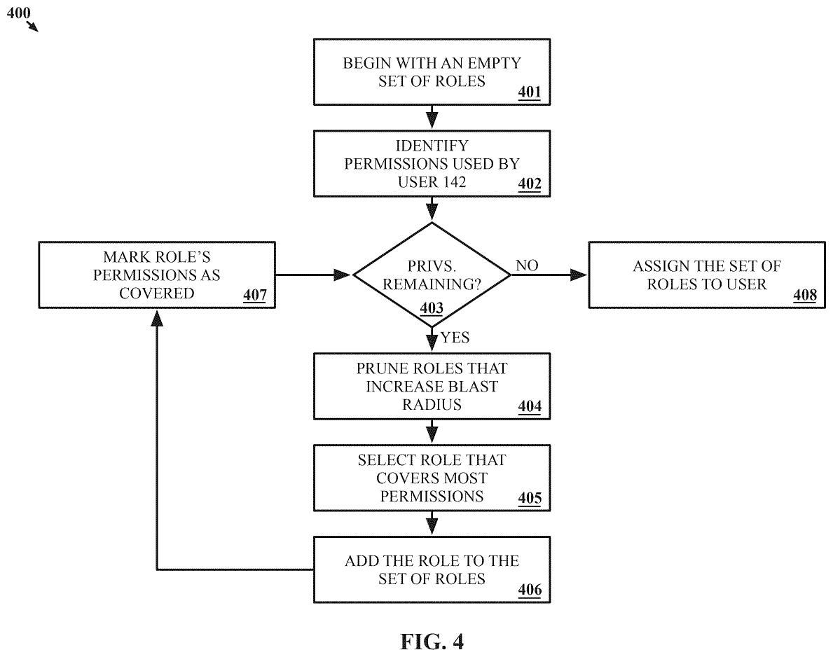

FIG. 4 illustrates operation 400 to reduce the number of unused permissions assigned to users. Operation 400 is an example that includes a greedy algorithm that permission reduction engine 101 may use to select roles for user 142 in a manner that limits extraneous permissions granted to user 142. Operation 400 begins with an empty set of roles (step 401). The set will be filled as a result of performing steps of the greedy algorithm that select roles for inclusion in the set. Permission reduction engine 101 identifies permissions used by user 142 (step 402). The permissions preferably represent all permissions user 142 uses to perform their duties. Permission reduction engine 101 may track which permissions are used by user 142 over a period of time, may query user 142 for the permissions they use, may query another user for the permissions used by user 142, or may obtain the permissions using some other mechanism.

For instance, in some examples, the identification of permissions may involve automated log analysis of identity platforms such as Microsoft Active Directory, Okta®, AWS IAM, or Google Workspace. These logs can provide granular details of resource access events, including timestamps and frequency of use, which help determine whether a permission is truly necessary. Alternatively, permission reduction engine 101 may employ predictive analytics or machine learning models trained on historical access patterns to infer permissions likely to be required for a given job role of user 142. This approach allows permission reduction engine 101 to adapt dynamically to changes in user behavior or organizational policies. In certain examples, permissions may also be weighted based on sensitivity or compliance requirements, such as those mandated by HIPAA or GDPR, ensuring that critical permissions are prioritized during role selection.

The greedy selection algorithm determines whether any of the identified permissions are not yet covered by, or included in, a role in the set of roles (step 403). In this first iteration of the algorithm, there are no roles, so no permissions are yet covered. As such, the algorithm continues to select a role from roles available for selection (e.g., all roles that can be assigned to a user in identity environments 103). Permission reduction engine 101 prunes the available roles that increase the blast radius of the set of roles (step 404). A blast radius is a value of the total number of permissions included in the role set divided by the number of permissions from the identified permissions (i.e., those permissions actually used by user 142). This may sometimes be referred to as a ratio. Since there are still no roles in the role set in this first iteration of the algorithm, it may not be possible to avoid increasing the blast radius of the set. As such, permission reduction engine 101 may skip step 404 on the first iteration.

In subsequent iterations, pruning becomes critical because adding a role with excessive permissions can significantly increase the blast radius, which correlates to the potential impact if the user account is compromised. For example, if the user requires 10 permissions and the current set grants 12, adding a role that raises the total to 50 permissions would increase the blast radius from 1.2 to 5.0, introducing unnecessary risk. The algorithm therefore excludes such roles unless they provide coverage of remaining required permissions. In alternative examples, the pruning logic may incorporate thresholds (e.g., defining allowable blast radius increases) or configurable policies, allowing administrators to define acceptable blast radius limits based on organizational security posture.

Permission reduction engine 101 then selects a role that covers most of the permissions used by user 142 relative to the other roles available for selection (step 405). For instance, if a first role includes six permissions while a second role only includes five permissions, then the first role will be selected. Permission reduction engine 101 adds the selected role to the set of roles for user 142 (step 406). The permissions that are covered by the added role are noted by permission reduction engine 101 as being covered so that permission reduction engine 101 can track which of the used permissions have yet to be covered by a role in the set (step 407).

In some examples, tie-breaking logic may be applied when multiple roles cover the same number of uncovered permissions. The system may then select the role with the smallest blast radius, and if still tied, the role with the fewest total permissions. This ensures that the algorithm not only maximizes coverage but also minimizes excess privileges, adhering to the principle of least privilege. Additionally, the algorithm may support dynamic updates, where roles are periodically re-evaluated as user behavior changes, ensuring continuous compliance with security policies. Alternative examples may also consider role hierarchies or inheritance structures, where selecting a parent role automatically grants child permissions, requiring additional logic to avoid redundant coverage.

Operation 400 then returns to step 403 where permission reduction engine 101 determines whether any of the used privileges remain to be included in a role of the set. It is possible that the role added on the first iteration covers all the permissions used by user 142. If that is the case, permission reduction engine 101 proceeds with assigning the set of roles to user 142 with just the one role (step 408). If, however, the one or more of the permissions used by user 142 are not covered by the set of roles, permission reduction engine 101 repeats step 404.

In some cases, the algorithm may complete in a single iteration for highly specialized roles that perfectly match user 142's used permissions. Conversely, if user 142 has broad access needs, multiple iterations may be required, and the algorithm ensures that each additional role selected provides incremental value without disproportionately increasing the blast radius. This iterative approach balances security and usability, reducing the likelihood of privilege creep while maintaining operational efficiency.

In the second, and all subsequent, iteration of step 404, permission reduction engine 101 prunes available roles that increase the blast radius of the role set. The available roles being pruned no longer include roles already in the set because it would not make sense to select a role more than once. In an example, the role set may currently include roles that include ten total permissions with five of those permissions being permissions that were used by user 142. The blast radius in that case is five. All roles that would increase the blast radius above five are excluded from selection at this step. Alternative examples may compute blast radius using weighted metrics, where permissions associated with sensitive resources contribute more heavily to the ratio. This allows organizations to prioritize minimizing exposure to critical systems even if the total number of permissions is relatively small. Additionally, pruning may incorporate historical usage data to deprioritize roles that include permissions rarely or never used by similar users, further reducing unnecessary access.

Permission reduction engine 101 selects a role covering most of the privileges used by user 142 relative to others of the remaining available roles after the pruning (step 405). The selected role is added to the set of roles (step 406) and additional privileges of the used privileges are marked as being covered (step 407). Operation 400 again returns to step 403 to determine whether additional one or more of the used permissions have yet to be covered. Steps 403-407 repeat until all the used permissions are covered by the set of roles. When all the permissions used by user 142 are covered, permission reduction engine 101 assigns the set of roles to user 142 (step 408).

In some examples, the final role set may be stored in a configuration database and periodically validated against updated access logs to ensure continued adherence to least privilege principles. For instance, permission reduction engine 101 may be configured to periodically repeat operation 400 to generate a new role set based off of permissions used by user 142 during the last period. Permission reduction engine 101 may also generate audit reports detailing the blast radius before and after optimization, providing transparency for compliance and security reviews. Furthermore, the algorithm can be extended to operate in batch mode for multiple users, leveraging clustering techniques to identify common permission patterns and optimize role assignments at scale.

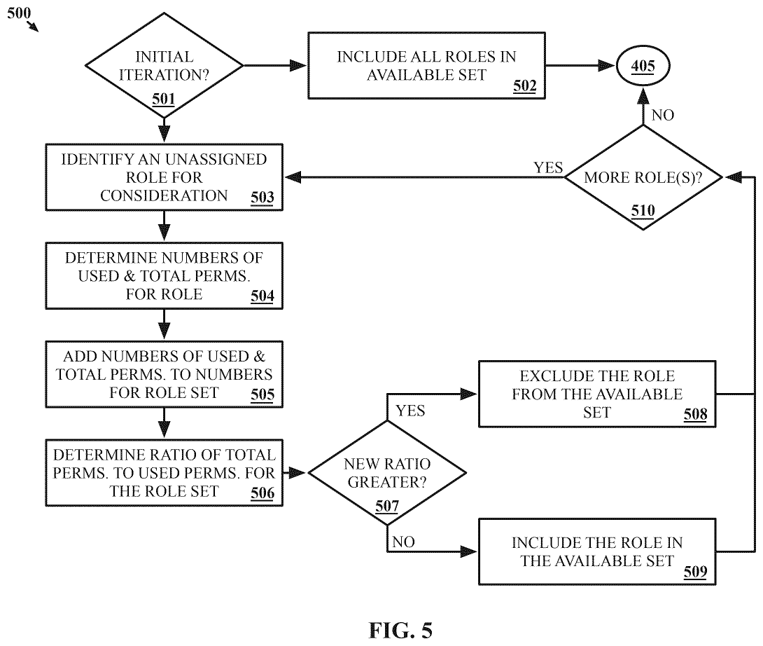

FIG. 5 illustrates operation 500 to reduce the number of unused permissions assigned to users. Operation 500 is an example of how step 404 may be performed in operation 400. Permission reduction engine 101 determines whether this is the initial iteration through step 404 to create the role set for user 142 (step 501). If it is the initial iteration, permission reduction engine 101 includes all roles in the available set for selection at step 405 (step 502). Permission reduction engine 101 then moves onto step 405. In some examples, the initial iteration may also involve pre-filtering roles based on organizational constraints, such as excluding deprecated roles or roles associated with inactive systems. This ensures that the algorithm does not waste computational resources evaluating roles that cannot be assigned. Additionally, permission reduction engine 101 may log metadata about the initial iteration, including the total number of roles considered and their associated permission counts, which may be useful for audit and compliance reporting.

If it is not the first iteration, permission reduction engine 101 identifies an unassigned role for consideration (step 503). An unassigned role is a role not already included in the role set for user 142 but one that is otherwise available for inclusion in the role set. Permission reduction engine 101 determines the number of the permissions used by user 142 covered by the role and the total number of permissions covered by the role. These values enable a new blast radius to be calculated for the role set should the role be added thereto. The total number of permissions for the role set is increased by the role's total number and the number of covered permissions used by user 142 is increased by the role's number of covered permissions (step 505). The ratio of this new total-permission number relative to the new covered-permission number is calculated (step 506). If this newly calculated ratio is greater than the ratio without the additional role's numbers (step 507), then the role is excluded, or pruned, from the roles available for selection (step 508). Otherwise, the role is included in the roles available for selection (step 509). It should be understood that the calculations and comparisons may be performed differently to achieve the same results. For example, permission reduction engine 101 may compute the ratio for the role and the ratio for the current set of roles and exclude the role if the role's ratio is greater than that of the current set of roles.

In alternative examples, the pruning logic may incorporate configurable thresholds, allowing administrators to define acceptable blast radius limits based on security policies. For instance, an organization may specify that any role increasing the blast radius beyond 2.0 should be excluded, regardless of coverage. Furthermore, the algorithm may apply weighting factors to permissions based on sensitivity, so that roles granting access to critical systems are evaluated more strictly than those granting access to low-risk resources. This approach enhances security by prioritizing minimization of high-impact permissions. Additionally, permission reduction engine 101 may support predictive pruning, where historical usage patterns are analyzed to deprioritize roles that include permissions rarely used by similar users, reducing unnecessary access while maintaining operational efficiency.

Permission reduction engine 101 determines whether there are more available roles to check for pruning (step 510). If not, permission reduction engine 101 proceeds to step 405. Otherwise, permission reduction engine 101 repeats steps 502-510 to consider a role that has not yet been evaluated. In some examples, the roles may be checked in parallel should processing resources permit. Parallel evaluation can significantly reduce computation time in large-scale environments where thousands of roles exist. For example, cloud-based implementations may leverage distributed computing frameworks to evaluate blast radius impacts concurrently across multiple nodes. In addition, permission reduction engine 101 may implement caching strategies to store intermediate blast radius calculations, avoiding redundant computations when similar role sets are evaluated. This optimization is particularly useful in enterprises with dynamic role structures, where frequent updates to permissions occur. Moreover, the algorithm may include a fallback mechanism to handle resource constraints, reverting to sequential evaluation when parallel processing is not feasible.

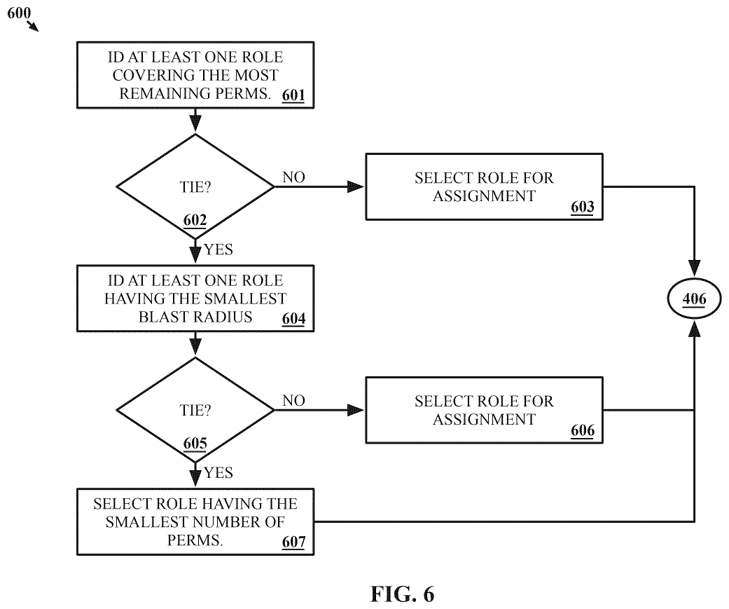

FIG. 6 illustrates operation 600 to reduce the number of unused permissions assigned to users. Operation 600 is an example of how step 405 may be performed in operation 400. Operation 600 is an example of what permission reduction engine 101 may do in the case of there being a tie between two or more roles during selection. Permission reduction engine 101 identifies one or more roles covering the most permissions used by user 142 that are not covered by roles already included in the set of roles for assignment to user 142 (step 601). At this point, permission reduction engine 101 does not care how many other permissions each of the one or more roles also covers, which is, at least in part, due to roles that increase the blast radius having already been pruned. Permission reduction engine 101 determines whether there is a tie with multiple roles covering the same number of the used permissions (step 602). The number of permissions, not which permissions are covered, matters for this selection process. If there is no tie (i.e., only one role is identified), permission reduction engine 101 selects that role for assignment to user 142 (i.e., for inclusion in the set of roles) (step 603) before moving on to step 406 in operation 400.

In some examples, permission reduction engine 101 may also log the tie-breaking process for audit purposes, including which roles were considered and the criteria applied at each decision point. This transparency may be important for compliance in regulated industries. Additionally, the algorithm may support administrator overrides, allowing manual intervention when business requirements dictate a specific role assignment despite tie-breaking logic. Such flexibility ensures that permission reduction engine 101 remains practical in real-world deployments where exceptions may occur.

If there is a tie between two or more roles, permission reduction engine 101 identifies one or more of those two or more roles having the smallest blast radius (step 604). Permission reduction engine 101 again checks to see if there is a tie between two or more roles identified at step 604 because it is possible that roles tied for covering the most permissions used by user 142 also have the same blast radius (step 605). If there is only one identified role, permission reduction engine 101 selects that role for inclusion in the role set before proceeding to step 406 (step 606). In alternative examples, blast radius may be calculated using weighted metrics, where permissions associated with sensitive resources contribute more heavily to the ratio. This ensures that roles granting access to critical systems are evaluated more strictly than those granting access to low-risk resources. Furthermore, the algorithm may incorporate historical usage data to break ties, favoring roles that have demonstrated consistent utility in similar user profiles.

If there is a tie in the roles having the smallest blast radius, then permission reduction engine 101 selects the role having the smallest number of permissions before advancing to step 406 (step 607). At this point, the likelihood of another tie involving roles with the same number of permissions is low; however, if such a tie occurs, permission reduction engine 101 may select one of the remaining roles arbitrarily before moving to step 406. Alternatively, permission reduction engine 101 may apply additional tie-breaking criteria before resorting to arbitrary selection. For example, the algorithm could prioritize roles associated with the least privileged job functions or roles that minimize cross-domain access. Alternatively, permission reduction engine 101 may implement deterministic selection based on role identifiers to ensure repeatability in automated processes. This prevents inconsistent behavior across multiple executions of the algorithm, which may be particularly important in environments subject to strict audit requirements.

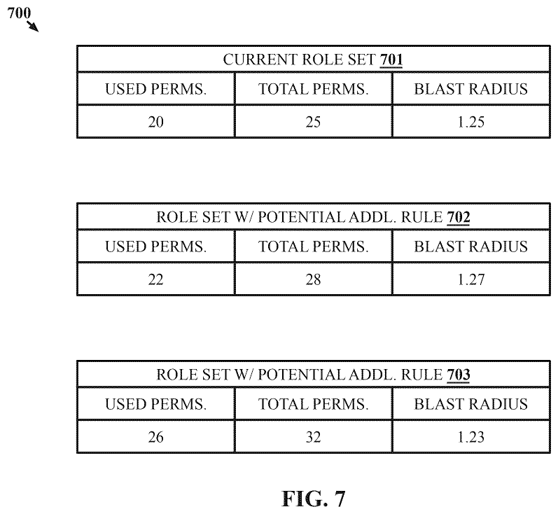

FIG. 7 illustrates operational scenario 700 to reduce the number of unused permissions assigned to users. Operational scenario 700 includes example role set statistics for three example role sets 701-703. Current role set 701 is an example of a role set to which permission reduction engine 101 has already added one or more roles through iterations of steps 403-407 of operation 400. Thus, when permission reduction engine 101 begins a next iteration of steps 403-407, the statistics shown for current role set 701 will serve as a basis for making decisions governed by blast radius.

For example, in step 404, permission reduction engine 101 prunes roles that would increase the blast radius of current role set 701. The current blast radius of current role set 701 is 1.25 since that is the value determined when the number of total permissions (i.e., 20) is divided by the number of permissions used by user 142 (i.e., 20). Possible role set 702 indicates what statistics for current role set 701 would be if a potential role was included in current role set 701. This potential role includes three extra total permissions and 2 extra permissions used by user 142. The blast radius, therefore, increases to 1.27 from the 1.25 blast radius of current role set 701. The potential role from possible role set 702 would be pruned at step 404 accordingly.

In contrast, possible role set 703 indicates what statistics for current role set 701 would be if a different potential role was included in current role set 701. This different potential role includes 7 extra total permissions and 6 extra permissions used by user 142. The blast radius, therefore, decreases to 1.23 from the 1.25 blast radius of current role set 701. The different potential role from possible role set 702 would not be pruned at step 404 and would be available for selection at step 405.

The above examples demonstrate how even a small increase in blast radius can trigger pruning when strict thresholds are enforced. In alternative examples, permission reduction engine 101 may allow configurable tolerance levels, such as permitting minor increases if the added role provides critical permissions. Furthermore, the algorithm may incorporate predictive modeling to estimate future blast radius trends based on anticipated role additions, enabling proactive pruning decisions.

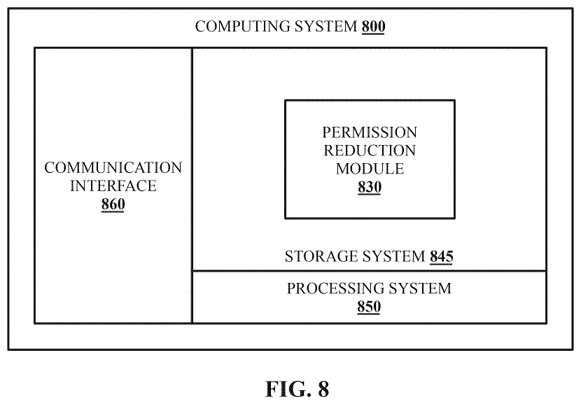

FIG. 8 illustrates computing system 800 for reducing the number of unused permissions assigned to users. Computing system 800 is representative of any computing system or systems with which the various operational architectures, processes, scenarios, and sequences disclosed herein can be implemented. Computing system 800 is an example architecture for permission reduction engine 101, data environments 102, identity environments 103, user terminal 104, and user terminal 105, although other examples may exist. Computing system 800 includes storage system 845, processing system 850, and communication interface 860. Processing system 850 is operatively linked to communication interface 860 and storage system 845. Communication interface 860 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency (RF), processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format - including combinations thereof. Communication interface 860 may be configured to communicate with other computing systems via one or more networks.

Processing system 850 comprises microprocessor and other circuitry that retrieves and executes operating software from storage system 845. Storage system 845 may include volatile and nonvolatile, removable, and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 845, or any other computer-readable storage medium herein, be considered a transitory form of signal transmission (often referred to as “signals per se”), such as a propagating electrical or electromagnetic signal or carrier wave.

Processing system 850 is typically mounted on a circuit board that may also hold the storage system. The operating software of storage system 845 comprises computer programs, firmware, or some other form of machine-readable program instructions. The operating software of storage system 845 comprises permission reduction module 830. The operating software on storage system 845 may further include an operating system, utilities, drivers, network interfaces, applications, or some other type of software. When read and executed by processing system 850 the operating software on storage system 845 directs computing system 800 to network routing advertisements as described herein. Permission reduction module 830 may execute natively on processing system 850 or the operating software may include virtualization software, such as a hypervisor, to virtualize computing hardware on which permission reduction module 830 executes.

In at least one example, permission reduction module 830 executes on processing system 850 and directs processing system 850 to track access permissions used by a user. Permission reduction module 830 also directs processing system 850 to iteratively add a role to a set of roles until the access permissions are captured by the set of roles. Each added role does not increase a ratio of total permissions captured by the set of roles to permissions of the access permissions captured by the set of roles. Permission reduction module 830 further directs processing system 850 to assign the set of roles to the user to enforce permissions in the set of roles.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method for reducing unused access permissions assigned to a user, the method comprising:
tracking used access permissions from a plurality of access permissions for a role that a user assigned the role uses during a period of time;
determining a different role with the used access permissions;
assigning the different role to the user; and
granting the user access to resources in accordance with the different role.

2. The method of claim 1, wherein the role is one of multiple roles assigned to the user and the plurality of access permissions are associated with the multiple roles.

3. The method of claim 1, wherein determining the different role comprises:
applying a greedy algorithm to roles available for assignment, wherein the greedy algorithm selects the different role.

4. The method of claim 1, wherein determining the different role comprises:
determining a set of roles, including the role, to be assigned to the user, wherein each role in the set of roles includes at least one of the used access permissions, and wherein the set of roles in aggregate includes the used access permissions.

5. The method of claim 4, wherein determining the set of roles comprises:
applying a greedy algorithm to roles available for assignment iteratively until the set of roles is complete, wherein each iteration of the greedy algorithm adds an additional role to the set of roles, and wherein the set of roles is complete when the used access permissions are included therein.

6. The method of claim 5, wherein applying the greedy algorithm includes:
after a first iteration of applying the greedy algorithm, identifying a subset of the roles available for assignment that will not increase a blast radius of roles already added to the set of roles; and
selecting a first role from the subset having a largest amount of the used permissions relative to other roles in the subset.

7. The method of claim 6, wherein selecting the first role comprises:
when more than one role of the subset has the largest amount, determining the first role as having a smaller blast radius than others of the more than one role of the subset.

8. The method of claim 7, wherein determining the first role comprises:
when than one role of the subset has the smaller blast radius, determining the first role as having a smaller number of permissions associated therewith than others of the more than one role of the subset.

9. The method of claim 6, wherein the subset of the roles includes all of the roles available for assignment during the first iteration.

10. The method of claim 1, comprising:
removing role from the user.

11. A method for reducing unused access permissions, the method comprising:
identifying access permissions used by a user;
applying a greedy algorithm to select a set of roles from a plurality of roles available for role-based access control (RBAC) to enable the access permissions, wherein each iteration of the greedy algorithm selects a different role for inclusion the set of roles based on a blast radius of the different role;
assigning the set of roles to the user; and
enforcing the access permissions granted by the set of roles.

12. The method of claim 11, wherein applying the greedy algorithm comprises:
pruning, from the plurality of roles, a subset of the plurality of roles that would increase the blast radius of roles already included in the set of roles.

13. The method of claim 11, wherein applying the greedy algorithm comprises:
adding a role from the plurality of roles to the set of roles that includes most permissions of the access permissions relative to other roles of the plurality of roles.

14. The method of claim 13, wherein adding the role comprises:
tiebreaking between two or more roles by selecting the role having a smallest blast radius of the two or more roles.

15. The method of claim 13, wherein adding the role comprises:
tiebreaking between two or more roles by selecting the role having a smallest number of permissions of the two or more roles.

16. The method of claim 13, wherein the greedy algorithm is used to add roles to the set of roles until each of the access permissions is covered by the set of roles.

17. The method of claim 11, comprising:
after assigning the set of roles to the user, identifying second access permissions used by the user;
applying the greedy algorithm to select a second set of roles from the plurality of roles to enable the second access permissions; and
assigning the second set of roles to the user.

18. The method of claim 11, wherein assigning the set of roles replaces a previously assigned set of roles of the user.

19. An apparatus for reducing unused access permissions, the apparatus comprising:
one or more computer readable storage media;
a processing system operatively coupled with the one or more computer readable storage media; and
program instructions stored on the one or more computer readable storage media that, when read and executed by the processing system, direct the apparatus to:
track access permissions used by a user;
iteratively add a role to a set of roles until the access permissions are captured by the set of roles, wherein each added role does not increase a ratio of total permissions captured by the set of roles to permissions of the access permissions captured by the set of roles; and
assign the set of roles to the user to enforce permissions in the set of roles.

20. The apparatus of claim 19, wherein each added role covers a largest portion of the access permissions yet to be covered by the set of roles without increasing the ratio.
